(19) United States
(12) Patent Application Publication
(10) Pub. No.: US 2026/0326378 A1
(43) Pub. Date: Oct. 22, 2026

(54) MODULAR WASHING SYSTEM AND METHOD FOR 3D-PRINTED OBJECTS

(71) Applicant: SprintRay Inc., Los Angeles, CA (US)

(72) Inventors: Shukun Ye, Los Angeles, CA (US); Songwei Li, Los Angeles, CA (US)

(21) Appl. No.: 19/724,712

(22) Filed: Jun. 29, 2026

Related U.S. Application Data
(63) Continuation-in-part of application No. 19/378,826, filed on Nov. 4, 2025.
Application No. 19/378,826 is a continuation of application No. 18/113,526, filed on Feb. 23, 2023, now Pat. No. 12,459,203.
Application No. 18/113,526 is a continuation-in-part of application No. 17/678,996, filed on Feb. 23, 2022, now Pat. No. 11,833,756.
Application No. 17/678,996 is a continuation of application No. 17/142,942, filed on Jan. 6, 2021, now Pat. No. 11,279,089.
(60) Provisional application No. 62/957,645, filed on Jan. 6, 2020.
(60) Provisional application No. 63/831,632, filed on Jun. 27, 2025.

(51) Int. Cl. B29C 64/35; B08B 3/02; B08B 3/04; B08B 3/10; B29C 64/245; B29C 64/386; B33Y 30/00; B33Y 40/20; B33Y 50/00

(52) U.S. Cl. CPC B29C 64/35; B08B 3/02; B08B 3/04; B08B 3/104; B29C 64/245; B29C 64/386; B08B 2220/04; B33Y 30/00; B33Y 40/20; B33Y 50/00

(57) ABSTRACT

A modular washing system cleans and dries three-dimensional (3D) printed objects. The system includes a main body housing a washing chamber, a wash solvent storage detachably connected to a backplate of the main body, and a pump that circulates wash solvent between the storage and the chamber. The detachable storage lets different solvents be used for different resins to reduce cross-contamination, and may carry an RFID tag read by the backplate to track solvent usage and type. An agitator in the chamber includes a three-bladed toroidal propeller in a closed-loop configuration with blades oriented near 45 degrees, reducing tip vortices and operational noise while driving fluid circulation. A two-phase process splash-washes and then immersion-rinses the object, after which a drying system directs airflow through the chamber. Centralized ribs direct solvent toward the object to improve cleaning.

### CROSS-REFERENCE TO RELATED APPLICATIONS

This application claims priority to U.S. Provisional Application No. 63/831,632 filed Jun. 27, 2025, and is a Continuation-in-part application of U.S. Non-provisional application Ser. No. 19/378,826 filed Nov. 4, 2025, which is a Continuation of U.S. Non-Provisional application Ser. No. 18/113,526, filed on Feb. 23, 2023, which is a Continuation in-part of Ser. No. 17/678,996, filed on Feb. 23, 2022, which is a Continuation of Ser. No. 17/142,942, filed on Jan. 6, 2021, which claims priority from U.S. Provisional Application 62/957,645, the disclosures of which are incorporated by reference in their entirety.

### FIELD OF THE INVENTION

The present disclosure relates to post-processing systems for 3D-printed objects, including a washing system and method for efficiently cleaning residual resin from 3D-printed objects using a modular design.

### BACKGROUND

Additive manufacturing technologies, such as 3D printing, have revolutionized prototyping and production processes across various industries. These technologies enable the creation of complex three-dimensional objects by depositing materials layer by layer based on digital models. Among the various 3D printing methods, photopolymerization techniques have gained popularity due to their ability to produce high-resolution parts with smooth surface finishes.

Photopolymerization 3D printing typically involves selectively curing liquid photopolymer resins using light sources such as ultraviolet (UV) lasers or projectors. As the resin is exposed to light, it solidifies, forming the desired object layer by layer. This process allows for the fabrication of intricate geometries and fine details that may be challenging to achieve with traditional manufacturing methods.

However, objects produced through photopolymerization 3D printing often require post-processing steps to achieve their final properties and appearance. One such step is washing, which involves removing excess uncured resin from the surface of the printed object. Proper washing is crucial for ensuring the quality, functionality, and safety of the final product.

Conventional washing methods for 3D-printed objects have involved manual techniques such as rinsing with solvents or immersing parts in ultrasonic cleaning baths. These approaches can be time-consuming, inconsistent, and may not effectively clean complex geometries or internal cavities. Additionally, manual washing processes may expose users to potentially harmful chemicals and generate excessive waste.

As the adoption of 3D printing technology continues to grow across industries such as healthcare, automotive, and consumer goods, there is an increasing demand for efficient and automated post-processing solutions. Improved washing systems can potentially enhance the overall quality of 3D-printed parts (e.g., surface quality), reduce material waste, and streamline production workflows.

However, traditional washing systems and methods often struggle to completely remove residual resin lingering on the surface of the 3D-printed objects during the washing stage. This residual resin then becomes cured onto the object's surface during the post-curing stage, significantly impacting both quality and appearance. Specifically, traditional washing systems and methods mainly suffer from the following issues.

First, traditional washing systems may include a risk of wash solvent cross-contamination. Traditional washing system may typically use an integrated wash solvent storage or receptacle fixed within the equipment, which may lack physical isolation. This design may lead to cross-contamination, for example, after washing a 3D-printed object made from standard resin, residual resin may dissolve into the solvent. If a biocompatible 3D-printed object is subsequently washed in this system, the pre-existing contamination may compromise its biocompatibility, posing a risk for oral applications. As such, a removable wash solvent storage device may address this issue as described herein, allowing a user to install a different storage device for different resins to avoid cross-contamination.

Second, traditional washing systems may suffer from significant operational noise. Many traditional washing systems employ propellers that may be driven to rotate in the washing/drying systems to continuously splash washing solution or generate airflow onto the surface of the 3D-printed object to be washed or dried. However, during operation, due to a pressure differential, specifically, lower air pressure on the upper surface of the propeller and higher air pressure on the lower surface, vortices may be generated at the blade tips. Furthermore, when the propeller operates at excessively high rotational speeds, the blades may disturb the surrounding air, resulting in the formation of turbulence. The generation of both vortices and turbulence during the cleaning/drying process may contribute to elevated operational noise.

Accordingly, there is a need for a modular washing system and method as described herein.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a washing apparatus for washing 3D-printed objects is provided. The washing apparatus includes a main body, a washing chamber disposed within the main body, a detachable wash solvent storage detachably connected to the main body, and a toroidal propeller disposed within the washing chamber. The toroidal propeller includes three blade elements arranged in a closed-loop configuration, wherein each blade element is oriented at an angle of approximately 45 degrees relative to a horizontal plane.

According to other aspects of the present disclosure, the washing apparatus may include one or more of the following features. The washing apparatus may further include a pump configured to circulate wash solvent between the detachable wash solvent storage and the washing chamber. The washing apparatus may further include a cover pivotally connected to the main body and configured to cover the washing chamber. The washing apparatus may further include a user interface disposed on a front side of the main body. The detachable wash solvent storage may be positioned on a rear side or a side of the main body. The main body may include a backplate with a receiving portion configured to receive the detachable wash solvent storage. The backplate may include a protrusion, and the detachable wash solvent storage may include a cavity shaped to match the protrusion. The backplate may include vertically extending slots, and the detachable wash solvent storage may include limit tabs configured to engage with the vertically extending slots. The detachable wash solvent storage may include an opening at a top of the cavity, and the backplate may include a conduit configured to connect to the opening. The washing apparatus may further include a sealing element positioned between the conduit and the opening. The detachable wash solvent storage may include positioning blocks, and the backplate may include corresponding positioning holes configured to engage with the positioning blocks. The detachable wash solvent storage may include a handle. The detachable wash solvent storage may include a radio-frequency identification (RFID) tag, and the backplate may include an RFID reader configured to read information stored in the RFID tag. The washing apparatus may further include an anti-leakage conduit configured to guide leakage wash solvent into the washing chamber. The washing chamber may include an adapter configured to accommodate one or more build platforms. The adapter may include a multi-step design with a plurality of steps configured to support build platforms of various sizes. The washing chamber may further include a cage configured to hold 3D-printed objects during washing. The washing chamber may include a plurality of centralized ribs configured to guide and concentrate splashing of wash solvent toward a center and upward within the washing chamber.

According to another aspect of the present disclosure, a method for washing 3D-printed objects is provided. The method includes performing a splash-washing step by adding wash solvent into a washing chamber such that a liquid level is above a surface of a toroidal propeller, and activating the toroidal propeller to perform a splash-washing process. The method further includes performing a rinsing-washing step by adding additional wash solvent into the washing chamber until a 3D-printed object is fully submerged, and activating the toroidal propeller to perform a gentle immersion rinse.

According to other aspects of the present disclosure, the method may include one or more of the following features. The splash-washing step may include rotating the toroidal propeller at 1800-2400 rpm. The rinsing-washing step may include rotating the toroidal propeller at 600-1000 rpm. The method may further include performing a drying step after the washing steps are completed.

According to another aspect of the present disclosure, a washing system for washing 3D-printed objects is provided. The washing system includes a wash solvent storage configured to store wash solvent, a pump configured to circulate the wash solvent, a washing chamber configured to receive a 3D-printed object to be washed, and a toroidal propeller disposed within the washing chamber. The toroidal propeller includes three blade elements arranged in a closed-loop configuration, wherein each blade element is oriented at an angle of approximately 45 degrees relative to a horizontal plane.

According to other aspects of the present disclosure, the washing system may include one or more of the following features. The washing system may further include a turbine fan configured to generate airflow for drying the 3D-printed object. The washing system may further include an exhaust pipe connected to the washing chamber and configured to guide airflow out of the washing chamber. The washing system may further include guiding structures disposed within the washing chamber and configured to guide airflow. The washing system may further include a vent connected to the exhaust pipe and configured to connect to an external air duct or air purification system. The vent may include a microswitch configured to enable the turbine fan to operate at higher power levels when the vent is connected to the external air duct or air purification system.

According to other aspects of the present disclosure, the washing system for cleaning a three-dimensional (3D) printed object may include a main body, a washing chamber disposed within the main body and configured to receive the 3D-printed object, a backplate of the main body, a wash solvent storage configured to hold a wash solvent, a connection interface detachably coupling the wash solvent storage to the backplate and establishing fluid communication therebetween, a pump fluidly coupled between the wash solvent storage and the washing chamber and configured to deliver the wash solvent from the wash solvent storage into the washing chamber and to return used wash solvent from the washing chamber to the wash solvent storage, and an agitator disposed in a lower portion of the washing chamber and configured to agitate the wash solvent within the washing chamber.

In other embodiments, the connection interface comprises mutually complementary mating features on the wash solvent storage and the backplate that cooperate to support, align, or retain the wash solvent storage relative to the backplate.

In other embodiments, the mating features comprise a protruding portion provided on one of the wash solvent storage and the backplate, and a receiving portion provided on the other of the wash solvent storage and the backplate and configured to receive the protruding portion.

In other embodiments, the backplate defines a recessed receiving portion and includes a protruding portion within the recessed receiving portion, and wherein the wash solvent storage has an outer contour shaped to be received by the recessed receiving portion and defines a storage cavity shaped to receive the protruding portion.

In other embodiments, the agitator comprises a toroidal propeller having a plurality of blade elements arranged in a closed-loop configuration.

In other embodiments, the plurality of blade elements comprises three blade elements, each blade element being oriented at an angle of between approximately 35 and 65 degrees relative to a horizontal plane.

In other embodiments, the wash solvent storage includes an identification element storing information about the wash solvent including at least one of a usage cycle and a solvent type, and wherein the backplate includes a reader configured to read the information from the identification element.

In other embodiments, the identification element comprises a radio-frequency identification (RFID) tag and the reader comprises an RFID reader, and wherein the washing system is configured to, based on the information, at least one of (i) prompt a user to replace the wash solvent and (ii) verify whether the wash solvent storage is properly seated on the backplate.

In other embodiments, the wash solvent storage includes an internal conduit and a filter element secured to an end of the internal conduit, the filter element comprising one of a sponge and a metal mesh and being configured to prevent debris from returning to the washing chamber when the wash solvent is pumped from the washing chamber.

In other embodiments, the washing system further comprises an anti-leakage conduit connecting the backplate to the washing chamber and configured to direct wash solvent leaked at the backplate into the washing chamber.

According to other aspects of the present disclosure, a method of washing a three-dimensional (3D) printed object may include delivering, with a pump, a wash solvent from a wash solvent storage into a washing chamber to a first level above an agitator, performing a splash-washing phase by activating the agitator to spray the wash solvent upward onto the 3D-printed object, and returning the wash solvent from the washing chamber to the wash solvent storage with the pump.

In other embodiments, the method may further comprise after the splash-washing phase and before returning the wash solvent, delivering additional wash solvent into the washing chamber to a second level at which the 3D-printed object is submerged, and performing an immersion-rinsing phase by operating the agitator to circulate the wash solvent around the submerged 3D-printed object.

In other embodiments, the agitator comprises a toroidal propeller having three blade elements arranged in a closed-loop configuration.

In other embodiments, during the splash-washing phase the agitator is rotated at about 1800 to 2400 rpm, and during the immersion-rinsing phase the agitator is rotated at a lower speed of about 600 to 1000 rpm.

In other embodiments, the first level is about 5 mm above a surface of the agitator and the second level is about 70 mm above the agitator.

In other embodiments, returning the wash solvent comprises reversing the pump to draw the used wash solvent from the washing chamber back to the wash solvent storage along a same conduit path used for the delivering.

In other embodiments, the method further comprises, after returning the wash solvent, drying the 3D-printed object by operating a drying system to direct a drying gas flow through the washing chamber.

According to other aspects of the present disclosure, a washing apparatus for a three-dimensional (3D) printed object may include a washing chamber configured to hold awash solvent and to receive the 3D-printed object, and a toroidal propeller disposed in a lower portion of the washing chamber and configured to agitate the wash solvent, wherein the toroidal propeller comprises a plurality of blade elements arranged in a closed-loop configuration, each blade element being oriented at an angle of between approximately 35 and 65 degrees relative to a horizontal plane, the closed-loop configuration being configured to reduce formation of tip vortices during rotation so as to lower operational noise relative to a non-closed-loop propeller.

In other embodiments, each blade element of the toroidal propeller is oriented at an angle of approximately 45 degrees relative to the horizontal plane.

In other embodiments, the washing apparatus further comprises a flow-directing feature extending inwardly from interior walls of the washing chamber and configured to redirect splashed wash solvent toward a center of, and upward within, the washing chamber, the flow-directing feature comprising one or more of a rib, a vane, a baffle, and a channel.

The presently disclosed modular washing system and method is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 illustrates an isometric view of a washing system in accordance with exemplary embodiments hereof.

FIG. 2 illustrates a schematic view of a washing system configuration in accordance with exemplary embodiments hereof.

FIG. 3 illustrates an exploded view of a solvent storage and backplate in accordance with exemplary embodiments hereof.

FIG. 4 and FIG. 5 illustrate an exploded view of a solvent storage and associated components in accordance with exemplary embodiments hereof.

FIG. 6 and FIG. 7 illustrate an interior view of a backplate in accordance with exemplary embodiments hereof.

FIG. 8 illustrates a solvent storage internal structure in accordance with exemplary embodiments hereof.

FIG. 9 illustrates a diagram of a circulation system for a washing system in accordance with exemplary embodiments hereof.

FIG. 10 and FIG. 11 illustrate a cross-sectional view of component connections in a washing system in accordance with exemplary embodiments hereof.

FIG. 12 and FIG. 13 illustrate a cross-sectional view of a washing chamber in accordance with exemplary embodiments hereof.

FIG. 14 and FIG. 15 illustrate a schematic diagram of a washing system in accordance with exemplary embodiments hereof.

FIG. 16 illustrates an isometric view of a drying system in accordance with exemplary embodiments hereof.

FIG. 17 illustrates a section view of a washing chamber with guiding structures in accordance with exemplary embodiments hereof.

FIG. 18 illustrates a top view of a toroidal propeller in accordance with exemplary embodiments hereof.

FIG. 19 illustrates a side view of a toroidal propeller in accordance with exemplary embodiments hereof.

FIG. 20 illustrates a cross-sectional view of a washing chamber with centralized ribs in accordance with exemplary embodiments hereof.

### DETAILED DESCRIPTION

Disclosed herein is a washing system, and associated systems and methods, for cleaning and drying three-dimensional (3D) printed objects.

As used herein, a 3D-printed object is any object produced, in whole or in part, by an additive manufacturing process, including, without limitation, vat photopolymerization (e.g., stereolithography (SLA) and digital light processing (DLP)), material jetting, material extrusion, powder-bed fusion, and binder jetting, and is not limited to photopolymer-resin parts. By way of non-limiting example, the 3D-printed object may comprise a dental or medical appliance or component (e.g., a clear aligner, retainer, crown, bridge, denture, night guard, surgical guide, or model) and/or any other 3D-printed object that may benefit from post-print washing.

In addition, although washing of 3D-printed objects is described primarily herein with reference to removing uncured or residual resin, the systems and methods herein may be used to remove any uncured material, support material, debris, particulate, process residue, or other surface or subsurface contaminant from the 3D-printed object, regardless of the additive manufacturing process used to form the object.

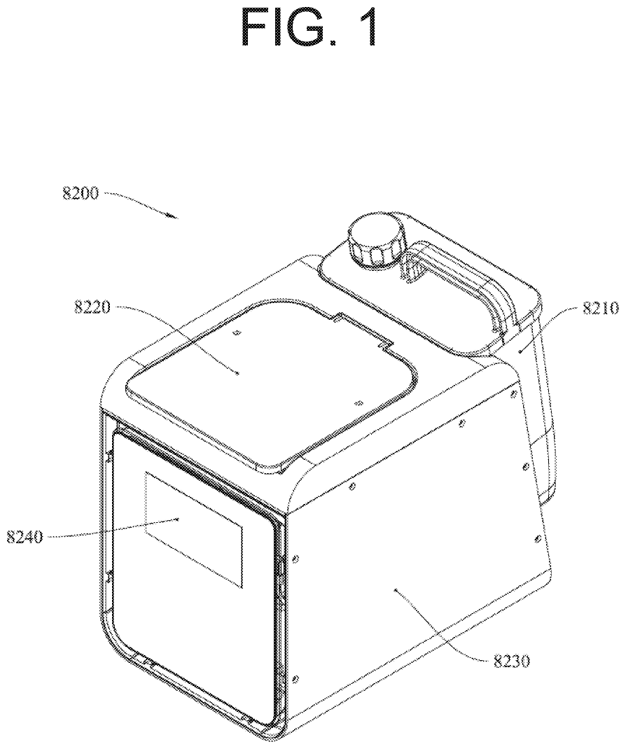

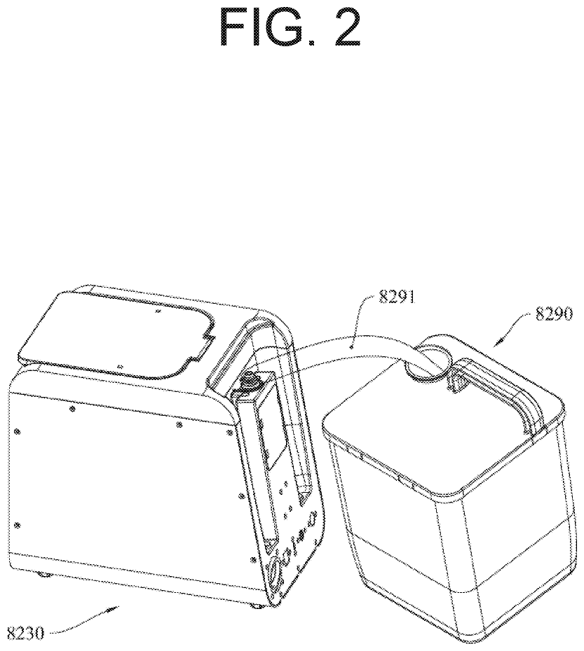

In some embodiments, with reference to FIG. 1, the washing system 8200 (also referred to herein as the “washing device”) includes a main body 8230, a user interface 8240, a cover 8220, and a wash solvent storage or receptacle 8210 (also referred to herein as the “storage”). With reference to FIG. 2, the washing system 8200 also may be configured to connect to an external solvent tank 8290.

The main body 8230 may form the primary structure of the washing system 8200, housing internal components and providing support for the other elements. In some embodiments, the main body 8230 may be constructed from durable materials suitable for containing cleaning solvents and withstanding repeated use.

In some embodiments, the user interface 8240 may include a display with a touch screen and may be disposed on the front side (or any other suitable side) of the main body 8230 for users to program, execute, or otherwise control features of the washing/drying system, adjust settings, and view status information. It is understood that the user interface 8240 is not limited to a touch-screen display and may additionally or alternatively include physical buttons, knobs, switches, indicator lights, audible indicators, voice control, or a remote interface (e.g., a companion application on a mobile device or computer).

In some embodiments, the washing system 8200 may further include a communication interface (e.g., Wi-Fi, Bluetooth, or wired) configured to communicate with a 3D printer, a post-curing device, a network, a server, or a cloud service, and the washing system 8200 may automatically select or adjust one or more washing or drying parameters based on information received therefrom and/or from the identification element (e.g., the RFID tag 8500), such as the resin or material type, part geometry, or print-job data.

In some embodiments, the cover 8220 is positioned above a washing chamber (e.g., located inside the main body 8230) and is connected to the main body 8230, e.g., via a hinge or pivot, allowing the cover 8220 to be opened to access the washing chamber and closed during operation. During the washing process, the cover 8220 remains closed to prevent contaminated wash solvent from splashing out of the chamber.

In some embodiments, a microswitch or other releasable locking mechanism may be provided at the connection between the cover 8220 and the main body 8230 to ensure that the cover 8220 is properly closed during the washing process. Furthermore, if the cover 8220 fails to close, or the user forgets to close it, the system 8200 may prevent the washing operation from being initiated, so as to prevent the wash solvent from splashing onto the workbench or the user. Additionally, the user interface 8240 may display an alert to remind the user to close the cover 8220.

In some embodiments, an upper cover seal may be provided at the cover 8220 to prevent air carrying wash solvent vapor (e.g., IPA) from escaping around the periphery of the cover 8220 during the cleaning or drying process. In some embodiments, redundant (“double”) protection may be provided to ensure that the cover 8220 is in a closed state before the cleaning and drying operations can begin. In some embodiments, redundant protection may likewise be provided to ensure that the wash solvent does not overflow within the washing chamber (i.e., the cleaning bucket) during operation.

### Wash Solvent Storage—Location and Detachability

In some embodiments, as shown in FIGS. 1 and 2, the wash solvent storage 8210 may be located at the rear side of the main body 8230 and may be detachably connected thereto. As such, the solvent storage 8210 also may be characterized as a removable, replaceable and/or interchangeable cartridge. The storage 8210 may be pre-filled with a wash solvent (e.g., IPA, alcohol, etc.). During the washing process, the washing system 8200 may pump the wash solvent from the storage 8210 into the washing chamber, and after finishing, the washing system 8200 may pump the contaminated or otherwise used solvent back into the storage 8210.

While isopropyl alcohol (IPA) and other alcohols are described as examples, the wash solvent is not limited thereto and may comprise any suitable cleaning agent, including, without limitation, alcohols (e.g., IPA, ethanol), glycol ethers (e.g., TPM, DPM), esters, ketones, hydrocarbon-based solvents, water, aqueous solutions, and surfactant- or detergent-based solutions, and combinations thereof, as appropriate for the material being cleaned.

In some embodiments, the storage 8210 may instead be positioned on a side of the main body 8230 (e.g., the right side, as viewed by a user facing the system) to facilitate user access and replacement, and the main body 8230 may extend to form a dedicated cavity for accommodating the storage 8210.

In some embodiments, as shown in FIG. 2, the storage 8210 also may be simply replaced with a connector 8291 (e.g., a pipeline) that extends between the main body 8230 and a high-capacity solvent tank 8290 (e.g., a one-gallon IPA bottle), enabling fluid communication between these components. This configuration may allow for increased solvent capacity and flexibility in solvent management.

In some embodiments, the storage 8210 may be provided with an opening to allow the user to pour out fully contaminated wash solvent and refill fresh solvent after cleaning.

Given the above, in some embodiments, the detachable storage 8210 not only allows for easy replacement when the wash solvent becomes contaminated but also enables users to select different storage 8210 based on the residual resin of the 3D-printed object, thereby effectively preventing cross-contamination. For instance, one storage 8210 may be dedicated to cleaning standard resin, while another may be reserved for bioprinted resin, and users may simply install the appropriate storage 8210 before initiating the washing process. In some embodiments, the storage 8210 may be refillable, single-use or disposable (e.g., implemented as a cartridge), or recyclable, and may be provided in a range of capacities and form factors.

### Storage-to-Backplate Connection

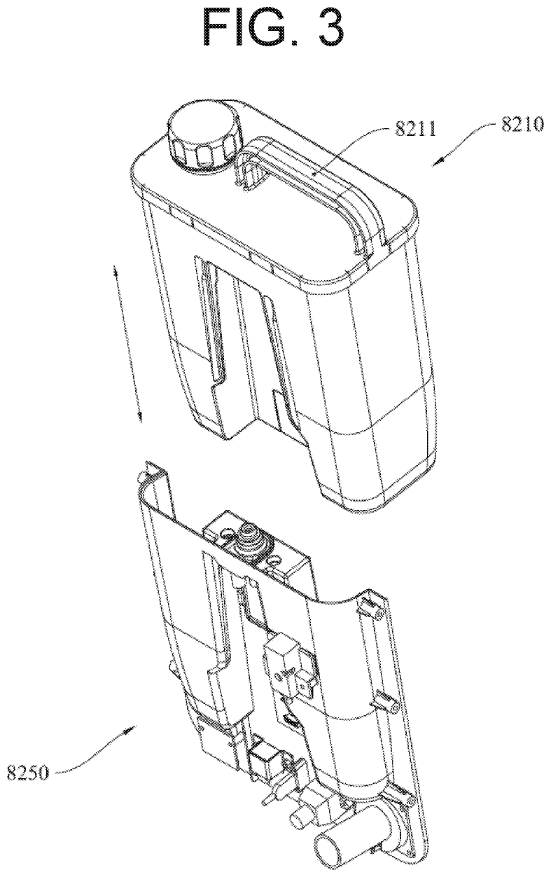

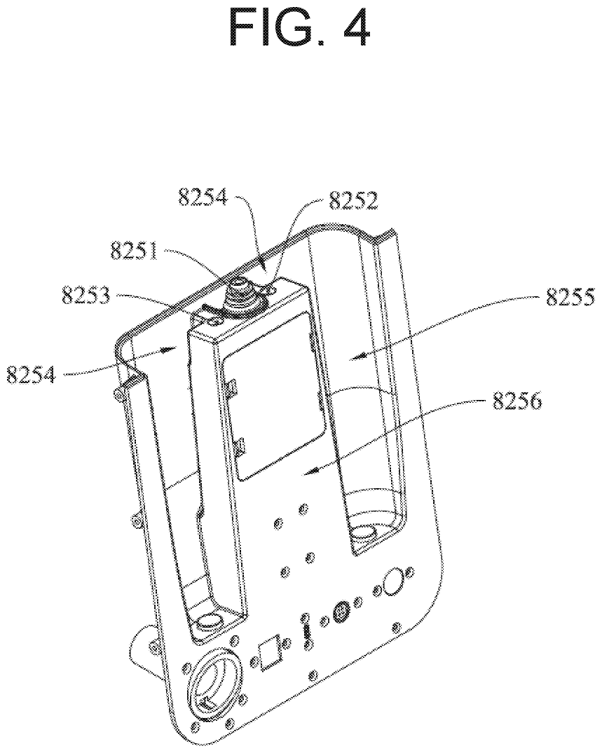

In some embodiments, as illustrated in FIGS. 3-6, the storage 8210 is configured to be detachably connected to a connection portion or backplate 8250 of the main body 8230. In some embodiments, the backplate 8250 may be recessed inwardly toward the interior of the main body 8230, forming a cavity (i.e., a receiving portion 8255) for receiving the storage 8210. Furthermore, a protruding portion 8256 may be provided within the receiving portion 8255 to support the storage 8210. Meanwhile, the storage 8210 may include an outer contour shaped to match the contour of the receiving portion 8255 and may include a storage cavity 8232 shaped to match and thereby receive the protruding portion 8256.

In some embodiments, two vertically extending slots 8254 may extend between the protruding portion 8256 and the receiving portion 8255 of the backplate 8250 and may engage with limit tabs 8231 extending along the sides of the storage 8210, thereby preventing the storage 8210 from slipping off the backplate 8250 when received thereby. As a result, during installation, the storage 8210 may be inserted vertically into the receiving portion 8255 of the backplate 8250 to supply wash solvent to the washing system 8200, and the slots 8254 may engage the tabs 8231 to hold the storage 8210 secure. Furthermore, other attachment mechanisms and/or methods may be used to connect the storage 8210 to the backplate 8250, such as magnets, latches, straps, and other suitable mechanisms or methods.

In some embodiments, the particular arrangement described above, in which the recessed receiving portion 8255 of the backplate 8250 includes the protruding portion 8256 and the storage 8210 includes the storage cavity 8232 that receives the protruding portion 8256, is exemplary and non-limiting, and the storage 8210 and the backplate 8250 may be detachably coupled by any suitable connection interface. For example, the male and female features may be reversed, such that the storage 8210 includes a protruding portion that is received within a cavity, recess, or socket of the backplate 8250. As a further example, neither component need define a recess at all, and instead, a protruding portion may project from an outer wall or surface of the backplate 8250 (or of the storage 8210) such that the storage 8210 seats on, against, over, or alongside the protruding portion without being received into any recessed receiving portion. More generally, either or both of the storage 8210 and the backplate 8250 may include any number, size, shape, and/or arrangement of mutually complementary mating features, e.g., one or more protrusions, posts, bosses, ribs, tabs, keys, rails, or flanges, and/or one or more recesses, cavities, sockets, grooves, slots, channels, or keyways or other suitable structures provided centrally, peripherally, on one or more sides, and/or on a substantially planar mating face, that cooperate to support, align, and/or retain the storage 8210 relative to the backplate 8250. The interface may additionally or alternatively employ any suitable detachable coupling, such as a friction or interference fit, a snap-fit or detent, a clip, clamp, hook, latch, strap, magnet, threaded engagement, bayonet, or twist-lock, or a quick-connect/quick-release coupling, and the storage 8210 may be engaged with the backplate 8250 by, e.g., inserting, dropping, sliding, rotating, twisting, and/or pressing the storage 8210 in any suitable direction. Accordingly, the connection interface between the storage 8210 and the backplate 8250 may take any form that detachably and mechanically couples the storage 8210 to the backplate 8250, so as to support, align, and/or retain the storage 8210, and that establishes fluid communication for transferring wash solvent between the storage 8210 and the washing system 8200 (e.g., by placing the solvent opening 8223 into sealed communication with a corresponding conduit and/or the sealing element 8251). Any such connection interface is within the scope of the present disclosure, which is not limited to the specific structural features illustrated and described.

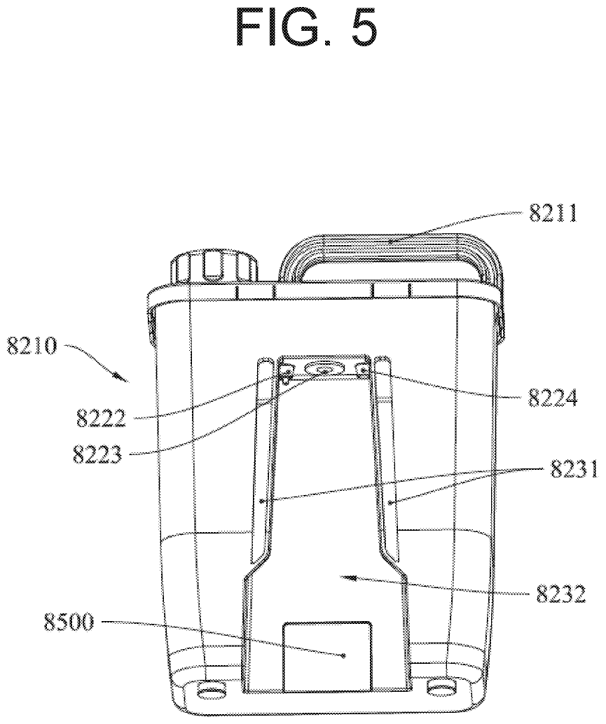

In some embodiments, as shown in FIG. 5, the storage 8210 includes a solvent opening 8223 at the top of the storage cavity 8232 enabling the supply and return of wash solvent to and from the washing chamber. Correspondingly, the protruding portion 8256 of the backplate 8250 may include a conduit that connects to the solvent opening 8223, e.g., with a sealing element 8251 positioned between the conduit and the opening 8223 to ensure proper sealing, as described in detail below.

In some embodiments, on both sides of the solvent opening 8223, two positioning blocks 8222, 8224 engage with corresponding positioning holes 8252, 8253 on the protruding portion 8256 to accurately align and secure the storage 8210 in place.

In some embodiments, a microswitch may be positioned near the positioning blocks 8222, 8224 and corresponding positioning holes 8252, 8253 to ensure that the storage 8210 is properly installed; if the storage 8210 is detected to be not correctly seated, the washing operation may not be initiated, and the user interface 8240 may display an alert to remind the user.

In some embodiments, as illustrated in FIGS. 3 and 5, the storage 8210 further includes a storage handle 8211 extending from an upper portion of the storage 8210, which is configured to facilitate grasping, removal, installation, and replacement of the storage 8210 relative to the backplate 8250.

### RFID Identification of Wash Solvent

In some embodiments, as illustrated in FIG. 5, the storage 8210 may further include an RFID tag 8500, which stores information about the wash solvent, including but not limited to usage cycles and solvent type.

For example, regarding usage cycles, by reading the information on the wash solvent's usage cycles stored in the RFID tag 8500, it is possible to determine whether the wash solvent is fully contaminated and/or has exceeded its designated usage period. This enables the washing system 8200 to prompt the user to replace it, thereby ensuring effective washing and equipment safety.

Regarding wash solvent type, when replacing or refilling the wash solvent, the washing system 8200 may read the information stored in the RFID tag 8500 regarding the wash solvent type being used and may display this information such that the user may replace the wash solvent with a matching or otherwise recommended type. This effectively prevents cross-contamination caused by chemical incompatibility and enhances the intelligence and safety of the washing process.

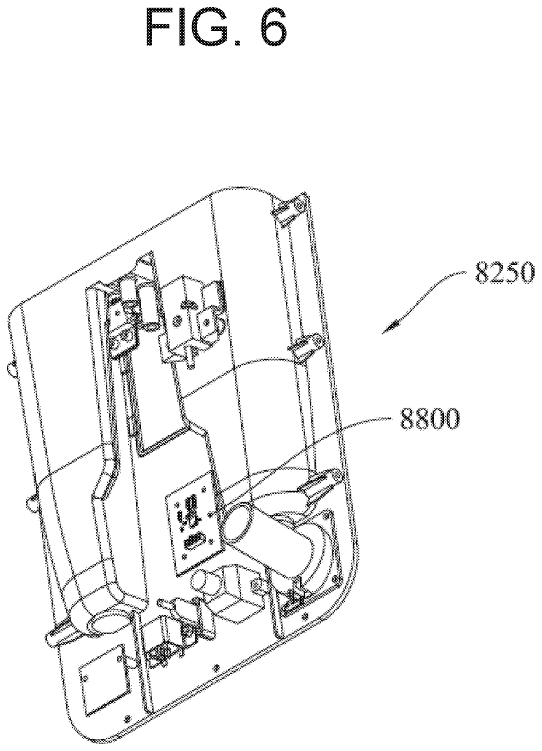

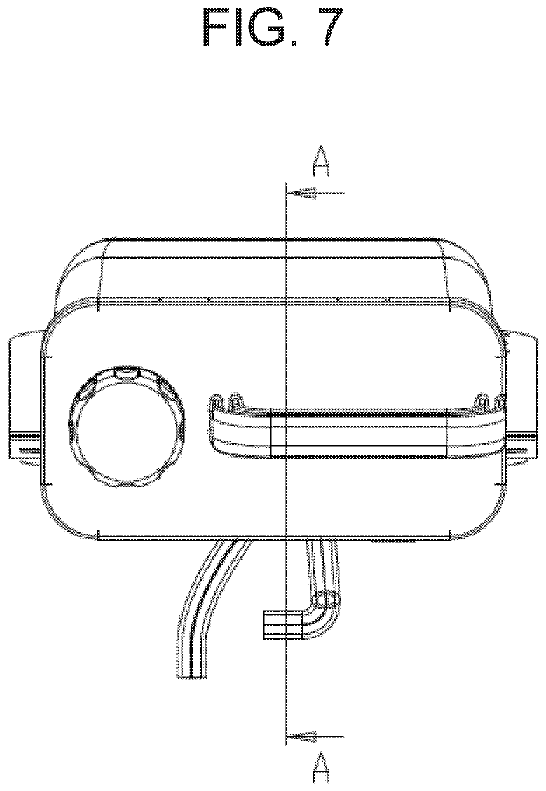

In some embodiments, as illustrated in FIG. 6, the backplate 8250 further includes a corresponding RFID reader 8800, which is configured to read the information/data stored in the RFID tag 8500. In addition, in some embodiments, the RFID tag 8500 and the corresponding RFID reader 8800 also may be configured to verify whether the storage 8210 is properly seated on the washing system 8200.

Although an RFID tag 8500 and RFID reader 8800 are described, the identification subsystem is not limited to RFID and may employ any suitable identification, memory, or communication technology, including, without limitation, near-field communication (NFC), a barcode or QR code with an optical reader, a contact memory or EEPROM device, a magnetic or mechanically-keyed identifier, or a wireless transceiver. Accordingly, the RFID tag 8500 and RFID reader 8800 may be referred to more generally as an identification element and a corresponding reader, respectively.

### Storage Internal Structure

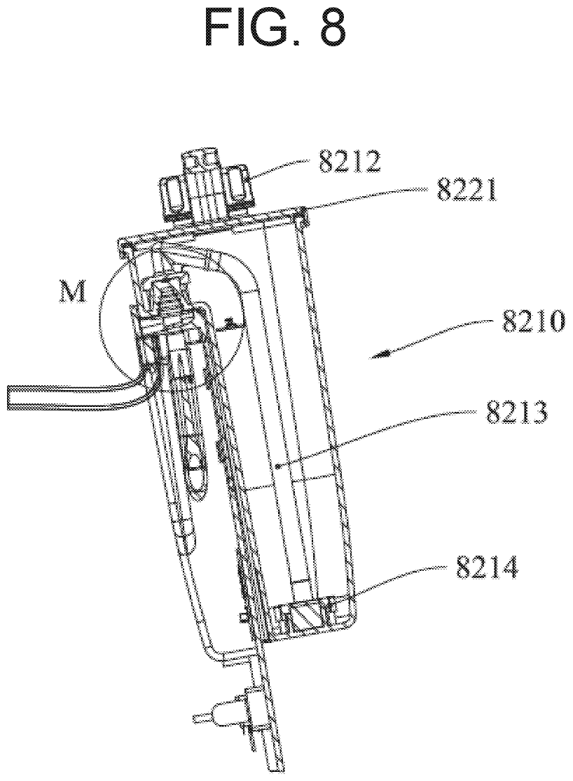

In some embodiments, as shown in FIG. 8, the storage 8210 may include a cap 8212 and a sealing lid 8221 at its top. The cap 8212 may be threadedly secured to the body of the storage 8210 and may be configured for pouring out fully contaminated wash solvent and refilling fresh wash solvent. The sealing lid 8221 may include a latching mechanism and an internal gasket, and also may be opened to allow users to clean the storage 8210.

In some embodiments, as shown in FIG. 8, the interior of the storage 8210 includes a conduit 8213, with one end connected to the solvent opening 8223 and the other end secured at the bottom of the storage 8210 by a fixing component 8214. The conduit 8213 is configured to guide the wash solvent to the solvent opening 8223 to provide the solvent to the washing chamber, as well as to receive the solvent from the washing chamber after use that is, to cycle the solvent between the storage 8210 and the washing chamber. The fixing component 8214 also secures a filter element to one end of the conduit 8213 within the storage 8210 to prevent debris or incompletely cured resin from returning to the cleaning tank when the liquid is pumped away.

In some embodiments, the filter element may comprise a sponge, the material of which may include a reticulated polyether foam with a pore density of 50 PPI, or other suitable materials.

In some embodiments, the filter element instead may comprise a metal mesh secured to the end of the conduit 8213. Employing a metal mesh in place of a sponge may avoid compression of the filter element by the flowing liquid, which compression could otherwise reduce or otherwise affect the flow rate of the wash solvent, thereby helping to maintain a consistent flow rate during operation. More generally, the filter element is not limited to a sponge or metal mesh and may comprise any suitable filter medium, e.g., a screen, mesh, membrane, sintered element, or porous body, of any suitable material and pore size.

### Circulation System and Pump

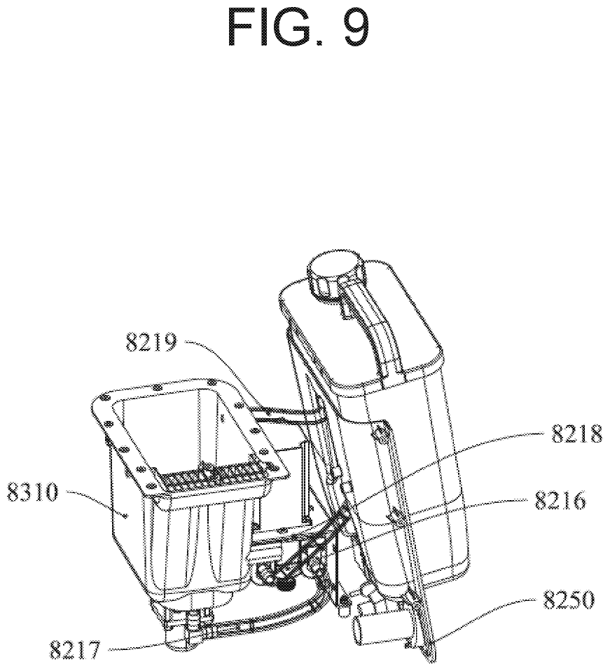

In some embodiments, as illustrated in FIG. 9, the backplate 8250 may be connected to a pump 8218 via a first conduit 8216, and the pump 8218 may be further connected to the washing chamber 8310 via a second conduit 8217, so as to cycle the wash solvent to clean the 3D-printed object. During the washing process, the pump 8218 may first extract the wash solvent from the storage 8210 and deliver it into the washing chamber 8310 through the first conduit 8216 and the second conduit 8217. After the washing process is finished, the pump 8218 may then return the wash solvent back to the storage 8210 along the same first and second conduits 8216, 8217.

In some embodiments, the pump 8218 may be a peristaltic pump, which may control forward and/or reverse flow of the wash solvent. The flow rate of the peristaltic pump may be 230-2600 mL/min. Other types of pumps also may be used; e.g., the pump 8218 may be two diaphragm pumps to achieve bidirectional liquid flow. The recited flow rate (e.g., about 230-2600 mL/min) is exemplary and non-limiting, and higher or lower flow rates may be used. The pump 8218 is likewise not limited to peristaltic or diaphragm pumps and may comprise any suitable pump, e.g., a gear pump, centrifugal pump, impeller pump, syringe pump, or a pressure or vacuum source, configured to move the wash solvent between the storage 8210 and the washing chamber 8310.

In some embodiments, the backplate 8250 may be directly connected to the washing chamber 8310 via an anti-leakage conduit 8219, so as to guide any leaked wash solvent into the washing chamber 8310, e.g., from the sealing element 8251.

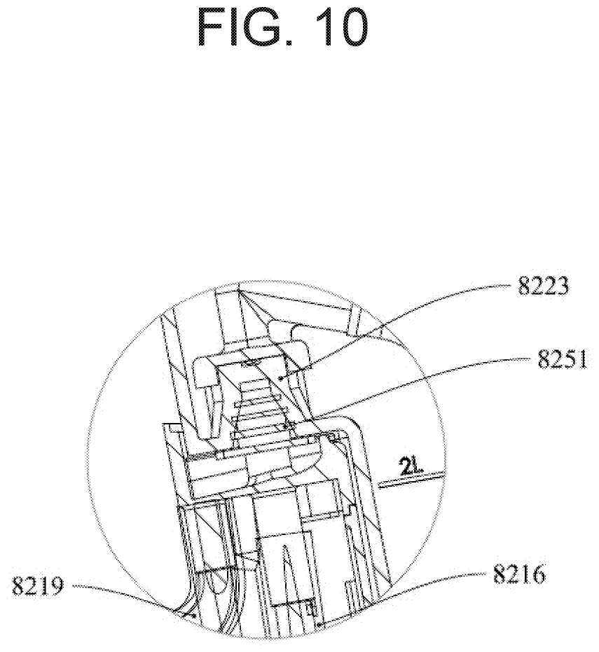

In some embodiments, as illustrated in FIG. 10, one end of the first conduit 8216 may be connected to the backplate 8250 and may be fixed with the sealing element 8251. When the storage 8210 is properly seated onto the backplate 8250, the solvent opening 8223 of the storage 8210 may fit closely with the sealing element 8251 to prevent wash solvent leakage.

In some embodiments, if the sealing element 8251 degrades and potentially fails (e.g., due to repeated use), the leaking wash solvent may be guided into the anti-leakage conduit 8219 and flow into the washing chamber 8310. Eventually, when the washing process is completed and the wash solvent returns to the storage 8210, the leaked wash solvent may also be returned along with it. This arrangement effectively prevents wash solvent from leaking into the internal structure of the washing system, thereby avoiding unnecessary risks.

### Washing Chamber—Adapter, Cover Ribs, and Cage

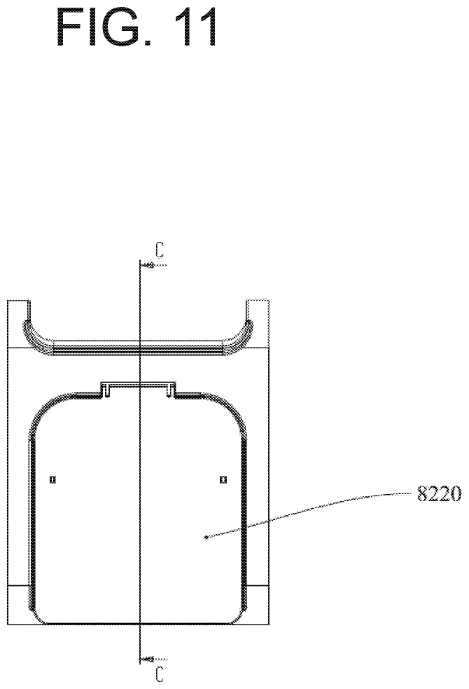

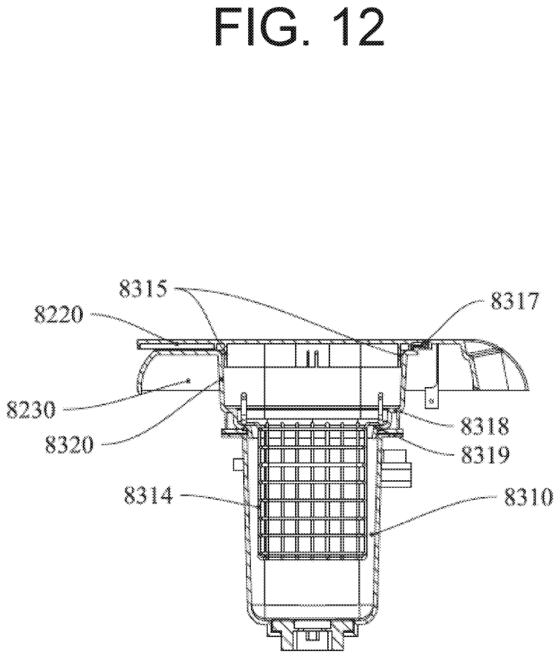

In some embodiments, as shown in FIGS. 11 and 12, the main body 8230 includes an adapter 8320 positioned beneath the cover 8220, within the interior of the washing chamber 8310, and configured to accommodate one or more build platforms. The adapter 8320 may include an anti-splashing design and may allow users to place a build platform, along with the 3D-printed object attached thereto, directly onto the adapter 8320 after printing and then initiate the washing process, thereby simplifying the procedure.

In some embodiments, the washing system 8200 may impart relative motion between the 3D-printed object 9400, the agitator 8400, and the wash solvent during washing. For example, the build platform 9401, the adapter 8320, the cage 8314, and/or a holder supporting the object may be rotated, oscillated, raised, lowered, or tilted, and/or the agitator 8400 may be moved within the washing chamber 8310, e.g., up or down or side-to-side, to enhance solvent contact, coverage, and cleaning of the object.

In some embodiments, the adapter 8320 may include a multi-step design with a plurality of side steps 8318, 8319 spaced at different distances and heights, upon which a build platform may rest, so that the side steps 8318, 8319 may support build platforms of various sizes. For example, the adapter 8320 may include a first step 8318 and a second step 8319 providing support surfaces at different heights within the washing chamber 8310.

In some embodiments, the adapter 8320 also may be sealed by the cover 8220. For example, the cover 8220 may extend downward along the upper edge contour of the adapter 8320 to form a protruding rib 8315 that may prevent the wash solvent from splashing out of the washing chamber 8310 during operation. The cover 8220 may be rotatably connected to the main body 8230 via a latch mechanism 8317 or similar, allowing for secure closure during the washing process. In other embodiments, the adapter 8320 may be an independent component or integrally formed as part of the main body 8230.

In some embodiments, the washing chamber 8310 may further include a cage 8314 as described in U.S. patent application Ser. No. 18/113,544, filed on Feb. 23, 2023, the entire contents of which are hereby fully incorporated herein by reference for all purposes. For 3D-printed objects that have been removed from the build platform, the 3D-printed objects may be placed into the cage 8314 to initiate the washing process. The cage 8314 may rest on the second step 8319 (or the first step 8318) and may prevent debris generated during washing from falling into the agitator 8400 (e.g., the toroidal propeller 8400 as described in other sections).

### Agitator/Toroidal Propeller

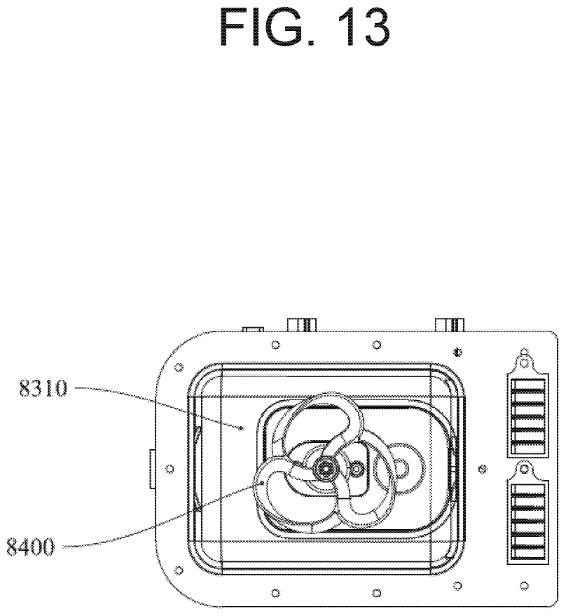

In some embodiments, as illustrated in FIG. 13, the washing chamber 8310 may further include an agitator 8400 situated within the lower portion of the washing chamber 8310, e.g., positioned below the cage 8314. In some embodiments, the agitator 8400 may include a propeller, e.g., a toroidal propeller, and in some embodiments, a three-bladed toroidal propeller in which three blade elements are arranged in a closed-loop configuration. This arrangement may allow for efficient and balanced rotation of the toroidal propeller 8400 during operation. More generally, the agitator 8400 may include any device or mechanism configured to impart motion to, or circulate, the wash solvent within the washing chamber 8310, and is not limited to a propeller. By way of non-limiting example, the agitator 8400 may comprise a propeller (including the toroidal propeller described herein), an impeller, a turbine, a rotor, a paddle, a pump-driven jet or nozzle arrangement, a magnetic stirrer, an ultrasonic transducer, other types of agitators and/or any combinations thereof.

In some embodiments, each of the blade elements of the toroidal propeller 8400 may be oriented at an angle of approximately 45 degrees relative to the horizontal plane. This blade angle may contribute to optimal fluid dynamics within the washing chamber 8310, enabling the toroidal propeller 8400 to generate both vertical and horizontal fluid movement and thereby enhancing the washing efficiency of the system. The approximately 45° angle represents a theoretical reference point for optimal blade orientation. In practical applications, the actual optimal angle may vary within a range of approximately 35-65° due to real-world factors not accounted for in simplified theoretical models, including liquid viscosity and surface tension effects, blade material properties and surface roughness, chamber geometry and wall interaction effects, dynamic seal friction and mechanical losses, operating temperature variations affecting fluid properties, and propeller manufacturing tolerances and blade profile variations.

In some embodiments, the blade angle may be selected based on technical analysis of blade angle optimization such but not limited to those shown below. While the vertical displacement of the projected wash solvent may generally follow the formula h=(v₀² sin² θ)/(2 g), optimal washing effectiveness may require maximizing both vertical splash and horizontal circulation.

In some embodiments, the total velocity utilization may be expressed as:

Washing Effectiveness∝v_vertical×v_horizontal=v₀² sin(θ)cos(θ)=(v₀²/2)sin(2θ)

Given the above, in some embodiments, the washing effectiveness may reach a maximum at θ=45°, where the vertical velocity component v₀ sin(45°)=0.707v₀ and the horizontal velocity component v₀ cos(45°)=0.707v₀, yielding maximum total velocity utilization.

In some embodiments, a comparative analysis of representative blade angles illustrates this balance. At 30°, the configuration provides good horizontal circulation (about 7.62 m/s) but less sufficient vertical splash (about 4.40 m/s). At 45°, the configuration provides an optimal balance (about 6.22 m/s in each direction), corresponding to maximum washing effectiveness. At 60°, the configuration provides high vertical splash (about 7.62 m/s) but less sufficient horizontal circulation (about 4.40 m/s).

The following Table 1 summarizes a comprehensive analysis of representative blade angles.

TABLE 1

| | Vertical | Horizontal | Total | | |
|---|---|---|---|---|---|
| Angle | Component | Component | Velocity | Washing | |
| (°) | (m/s) | (m/s) | Utilization | Effectiveness | |
| 30 | 4.40 | 7.62 | 33.53 | 85% | (too flat) |
| 45 | 6.22 | 6.22 | 38.72 | 100% | (optimal) |
| 60 | 7.62 | 4.40 | 33.53 | 75% | (too steep) |
| 75 | 8.50 | 2.28 | 19.36 | 60% | (very steep) |

In some embodiments, the approximately 45° orientation may be optimal because it may provide balanced vertical and horizontal velocity components (each about 6.2 m/s), may maximize velocity utilization (the product of the vertical and horizontal components being about 38.7), and may satisfy the practical washing requirement for both splash height and circulation. As practical considerations, at angles of about 60° and above, the liquid may be projected too vertically, resulting in less horizontal mixing. At angles of about 30° and below, circulation may be good but splash height may be insufficient. And at about 45°, a balance suitable for mechanical washing action may be achieved.

In some embodiments, testing comparing toroidal propeller configurations confirmed the selected design. A three-bladed toroidal propeller provided optimal performance; a five-bladed toroidal propeller exhibited reduced individual blade efficiency; a six-bladed toroidal propeller exhibited diminished returns due to increased flow interference; and a traditional wing-style three-bladed propeller, used as a baseline comparison, exhibited inferior vertical displacement. Blade angle optimization confirmed that the 45-degree configuration provides maximum liquid elevation while maintaining adequate horizontal circulation patterns. The foregoing comparative results are illustrative of particular tested embodiments and are not limiting. The toroidal propeller 8400 may include any suitable number of blade elements, e.g., two, three, four, five, six, or more, with three blade elements being one example that performed well under the tested conditions. Likewise, references herein to an “optimal” angle, blade count, or configuration denote results observed for particular embodiments and parameters and do not exclude other angles, blade counts, or configurations from the scope of the disclosure.

In some embodiments, the toroidal shape of the propeller 8400 may enable continuous fluid circulation within the washing chamber 8310, creating a toroidal flow pattern in which fluid is drawn inward at the center of the propeller and expelled outward at the edges. This flow pattern may facilitate thorough cleaning of 3D-printed objects by ensuring consistent solvent contact with object surfaces.

In some embodiments, the closed-loop configuration of the toroidal propeller 8400 may help reduce the formation of tip vortices at the blade tips during operation as compared to conventional propellers, thereby decreasing turbulence and lowering operational noise during the washing process. The reduction in turbulence may also help maintain a more stable and uniform flow pattern within the washing chamber 8310. The symmetrical arrangement of the three blades may further contribute to smooth, balanced rotation while providing a balance between fluid agitation and energy efficiency.

### Washing System and Method

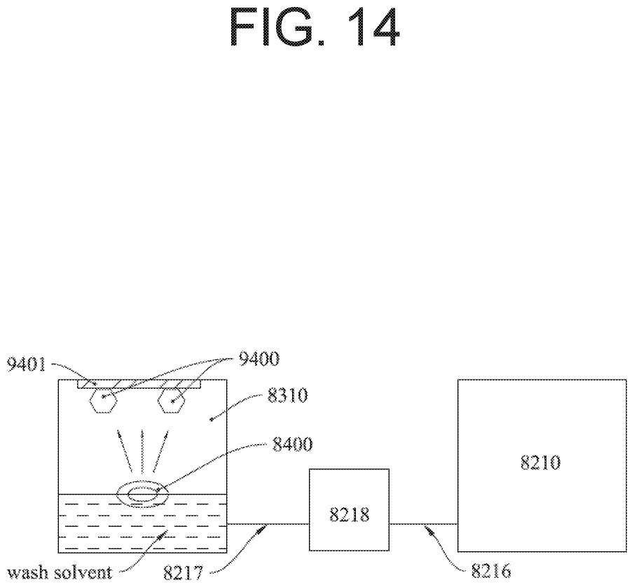

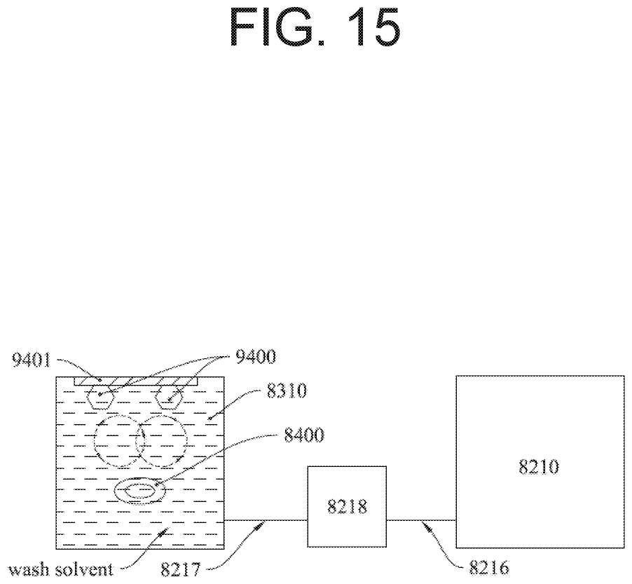

The present disclosure further provides a washing system 8200 and method based on the toroidal propeller 8400. In some embodiments, as illustrated in FIGS. 14 and 15, the washing system 8200 may include the following elements:

Wash solvent storage 8210, adapted to store wash solvents (such as IPA, alcohol, etc.) and to supply the necessary wash solvents for the washing process;

Pump 8218, which enables the circulation and transfer of the wash solvent by pumping the solvent from the storage 8210 into the washing chamber 8310 and then returning the used solvent back to the storage 8210; and

Washing chamber 8310, which serves as the core washing area used for washing 3D-printed objects 9400 and which may include the agitator/toroidal propeller 8400 that generates a stable and efficient fluid circulation of the solvent to enhance washing performance while effectively reducing operational noise of the washing system 8200.

In addition, several conduits 8216, 8217 may be used to fluidly connect the wash solvent storage 8210, the pump 8218, and the washing chamber 8310 together, thereby enabling the inflow and outflow circulation of the wash solvent. The washing system 8200 may be designed to accommodate a build platform 9401 supporting a printed object 9400, the build platform 9401 being positioned within the washing chamber 8310 above the toroidal propeller 8400.

In some embodiments, with reference to FIGS. 14 and 15, washing a 3D-printed part using the washing system 8200 may include the following two-phase process. The two-phase process is exemplary and non-limiting. In various embodiments, the washing process may include a single phase or one, two, three, or more phases. Furthermore, the splash-washing and immersion-rinsing phases may be performed in any order, repeated one or more times, partially overlapped, or combined, and one or more phases may be omitted. Likewise, the recited fill levels, rotational speeds, and durations are examples only, and other values, ranges, profiles (e.g., ramped, pulsed, or oscillating speeds), and sequences may be used depending on the material, geometry, and contamination level of the 3D-printed object 9400 and/or user-defined settings.

STEP 1—Splash Washing: First, wash solvent may be added into the washing chamber 8310, e.g., using the pump 8218, so that the liquid level is above the surface of the agitator 8400 (e.g., the toroidal propeller), e.g., about 5 mm above. Next, the agitator 8400 may be activated to perform a splash-washing process that may spray the wash solvent upward onto the 3D-printed object 9400 below the build platform 9401. This may be performed for about 3 minutes (and/or a suitable amount of time based on material characteristics and/or user-defined settings). During the splash-washing phase, the agitator 8400 may rotate at about 1800-2400 rpm, and preferably at about 2100 rpm. As such, this washing phase may utilize aggressive mechanical agitation through liquid projection, thereby removing uncured resin and surface contaminants from the accessible external geometries of the 3D-printed object 9400.

STEP 2—Immersion Rinse: Next, an additional portion of the wash solvent may be pumped into the washing chamber 8310 until the 3D-printed object 9400 is fully submerged, e.g., reaching a liquid level approximately 70 mm above the agitator 8400. The agitator 8400 may then be reactivated to gently circulate the solvent surrounding the object for about 3 minutes (or another suitable amount of time), e.g., operating at about 600-1000 rpm, and preferably at about 800 rpm. This step may ensure solvent penetration into complex geometries, undercuts, and internal cavities of the printed part, enabling thorough rinsing of residual resin.

Then, after both washing phases are completed, the used wash solvent may be drained back into the storage 8210 via the pump 8218, through the same pathway of the second conduit 8217, the pump 8218, and the first conduit 8216. Subsequently, the washing system 8200 may perform an air-drying process on the 3D-printed object 9400 to dry the part.

### Drying System and Method

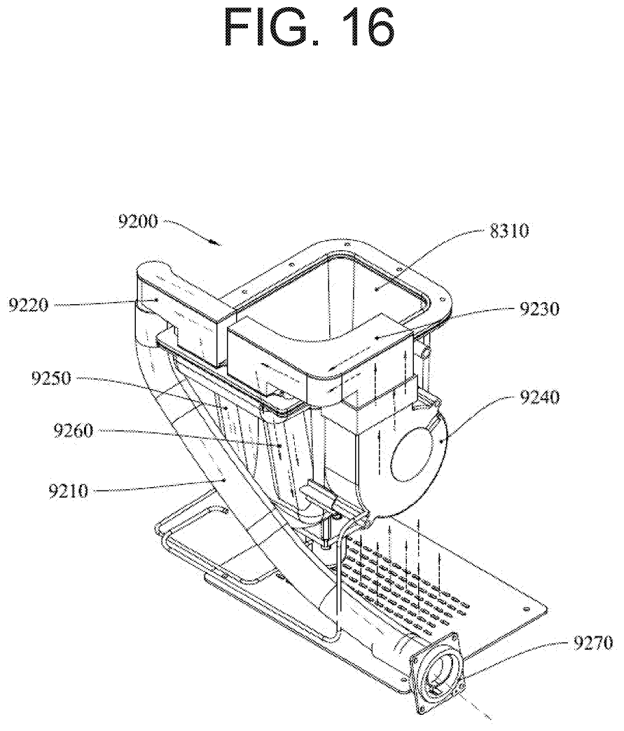

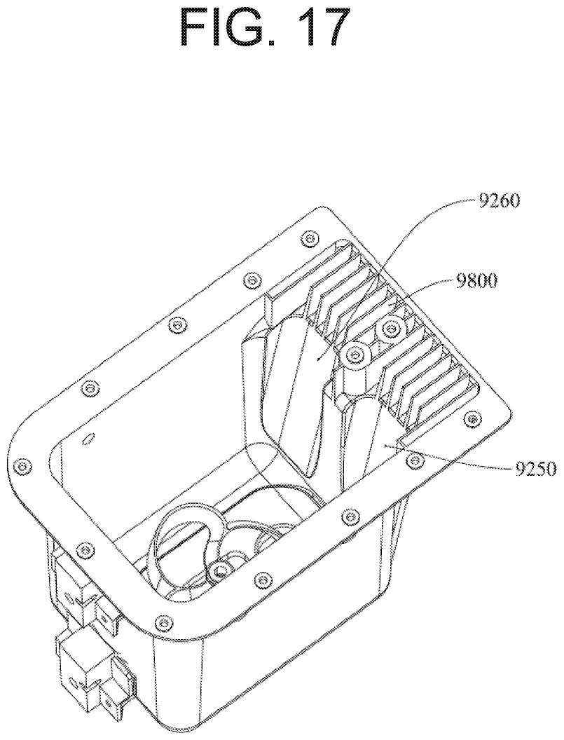

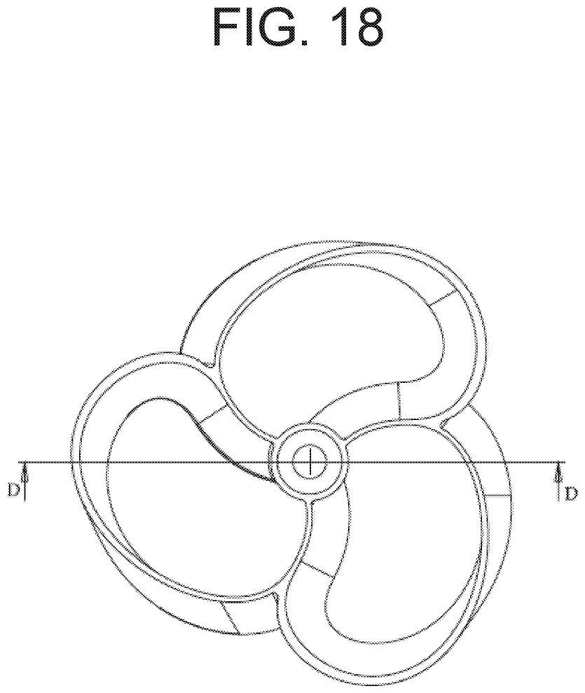

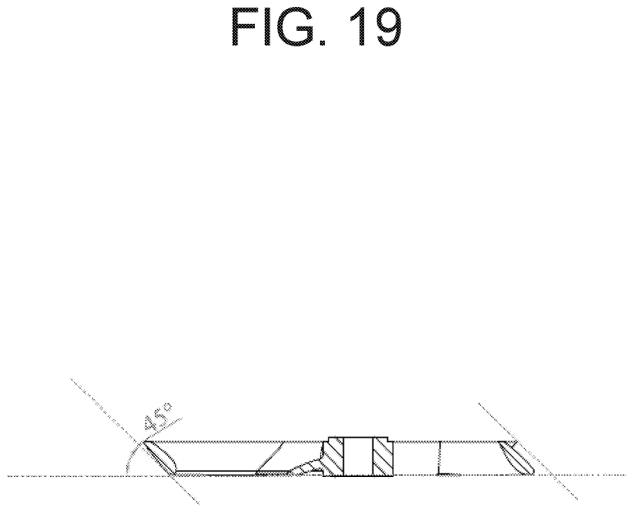

In some embodiments, as illustrated in FIGS. 16 and 17, the system 8200 may include a drying system 9200 that may include a turbine fan 9240, an exhaust pipe 9210, an intake channel 9230, an exhaust channel 9220, and several guiding structures and channels.

In some embodiments, while performing the drying operation, the turbine fan 9240 will be activated to generate an airflow that may enter the washing chamber 8310 via the intake channel 9230 to dry the 3D-printed object. After circulating within the washing chamber 8310, the airflow may be guided to the external environment via the exhaust channel 9220 and the exhaust pipe 9210. In some embodiments, the turbine fan 9240 and/or the intake channel 9230 may include a heating element to heat the airflow.

In some embodiments, as shown in FIG. 17, one or more diffusion ribs 9800 may be arranged at the air inlet and outlet of the washing chamber 8310 to diffuse the airflow and enhance the drying effect, potentially improving drying uniformity across the surface of the 3D-printed object. Beneath the inlet and outlet, the washing chamber 8310 may further include a first guiding structure 9250 and a second guiding structure 9260 to guide the airflow and reduce resistance as the air enters and exits the washing chamber 8310.

In some embodiments, the output end of the exhaust pipe 9210 may be connected to a vent 9270. The vent 9270 may connect to an external air duct or air purification system to control airflow and odors. In some embodiments, the vent 9270 may further include a microswitch that may be triggered when the vent 9270 is connected to an external air duct or air purification system, such that the turbine fan 9240 may be enabled to operate at higher power levels e.g., at a normal operating condition of about 21 W or at a high-load operating condition of about 42 W so as to enhance air-drying efficiency.

In some embodiments, the agitator 8400 also may be activated to provide vertical airflow for drying the 3D-printed object during and/or separate from this drying process.

In some embodiments, the drying method may include the following steps: first, the turbine fan 9240 may be activated to produce airflow that may enter the washing chamber 8310 via the intake channel 9230; next, the airflow may dry the 3D-printed object inside the chamber 8310, and the airflow may exit the chamber 8310 through the exhaust channel 9220 and the exhaust pipe 9210 to the external environment.

Furthermore, it is appreciated that the drying system 9200 is not limited to forced-air drying. In some embodiments, drying may additionally or alternatively be performed by heated air, vacuum or reduced-pressure drying, centrifugal or spin drying (e.g., by rotating the build platform 9401, a holder, and/or the object), radiant drying (e.g., infrared), inert-gas purging, or any combination thereof, with or without the airflow generated by the turbine fan 9240.

### Centralized Ribs

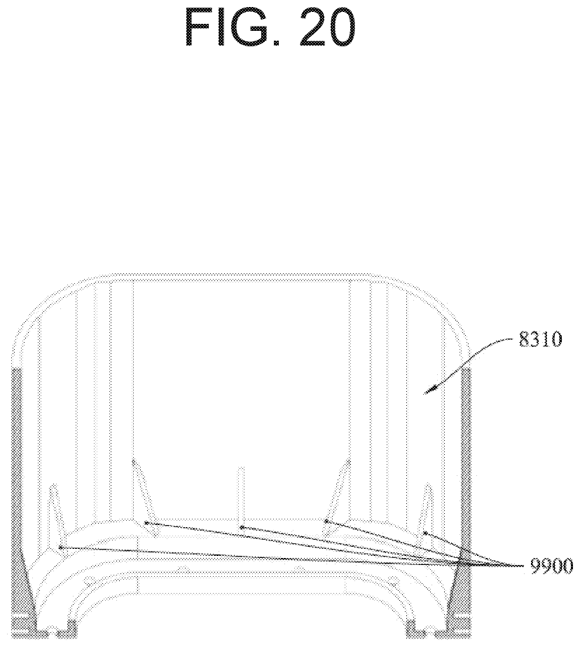

In some embodiments, as shown in FIG. 20, the washing system 8200 may include centralized ribs 9900 arranged within the washing chamber 8310 and configured to guide and concentrate the flow of wash solvent during the cleaning process. The centralized ribs 9900 may extend inwardly from the interior walls of the washing chamber 8310 and may be oriented to direct fluid flow in a specific pattern within the washing chamber 8310.

In some embodiments, the arrangement of the centralized ribs 9900 may be designed to guide the splashing of wash solvent toward the center and upward within the washing chamber 8310, creating a more focused and directed flow pattern of the wash solvent. When wash solvent contacts the centralized ribs 9900, the centralized ribs 9900 may redirect the flow of the solvent, resulting in an enhanced upward movement of the wash solvent within the washing chamber 8310. This upward movement may help the wash solvent reach higher areas of the printed object being cleaned.

In some embodiments, the centralized ribs 9900 may work in conjunction with other components of the washing system 8200, such as the toroidal propeller 8400, such that the combination of the centralized ribs 9900 and the fluid movement generated by the toroidal propeller 8400 may contribute to improved washing efficiency. The shape and positioning of the centralized ribs 9900 may be optimized to enhance the cleaning process; for example, the centralized ribs 9900 may have curved or angled surfaces to facilitate smooth redirection of the wash solvent flow. The centralized ribs 9900 may also assist in reducing turbulence and promoting a more uniform distribution of wash solvent throughout the washing chamber 8310.

In some embodiments, the material of the centralized ribs 9900 may be selected to withstand prolonged exposure to wash solvents and repeated cleaning cycles. The centralized ribs 9900 may be integrally formed with the walls of the washing chamber 8310 or may be separate components attached to the interior of the washing chamber 8310.

Furthermore, it is appreciated that the centralized ribs 9900 are one example of a flow-directing feature, and the disclosure is not limited to ribs. In other embodiments, the flow-directing feature may comprise one or more ribs, vanes, baffles, fins, channels, protrusions, deflectors, or contoured wall surfaces, formed on, in, or attached to the washing chamber 8310 and arranged to direct, concentrate, or redirect the wash solvent toward a center of, and/or upward within, the washing chamber 8310.

### Overall Operation

The washing system 8200 may integrate the above components to perform efficient washing and drying of 3D-printed objects, and the system's modular design may allow for flexibility in operation and maintenance. In some embodiments, the washing process may begin with the user loading a 3D-printed object into the washing chamber 8310. The object may be placed directly on the adapter 8320 within the washing chamber 8310, or in the cage 8314 for smaller or more delicate items.

Once the object is loaded, the user may initiate the washing cycle through the user interface 8240. The washing system 8200 may then begin the two-phase washing process. In the first phase, the pump 8218 may draw wash solvent from the storage 8210 and deliver it to the washing chamber 8310 to a level just above the toroidal propeller 8400, and the toroidal propeller 8400 may then activate to create a splashing action that aggressively cleans the exterior surfaces of the 3D-printed object, helping to remove uncured resin and surface contaminants. In the second phase, additional wash solvent may be pumped into the washing chamber 8310 until the 3D-printed object is fully submerged, and the toroidal propeller 8400 may operate at a lower speed to gently circulate the solvent around the object, helping to clean more complex geometries and internal cavities of the printed object.

After the washing phases are complete, the pump 8218 may reverse its operation, returning the used wash solvent to the storage 8210. The modular design of the storage 8210 may allow for easy replacement of, or switching between, different types of solvents without risk of cross-contamination.

Following the washing process, the drying system 9200 may activate. The turbine fan 9240 may generate airflow, which enters the washing chamber 8310 through the intake channel 9230. The guiding structures 9250, 9260 and diffusion ribs 9800 within the washing chamber 8310 may help direct and distribute the airflow around the 3D-printed object. The airflow may circulate through the washing chamber 8310, removing residual moisture from the object's surface, and the used air may then exit through the exhaust channel 9220 and be directed out of the system 8200 via the exhaust pipe 9210 and the vent 9270.

Throughout the process, the user interface 8240 may provide status updates and allow for adjustments to cycle parameters. The modular design of the system 8200 may facilitate maintenance and customization; for example, the detachable storage 8210 may be easily replaced or refilled, and the adapter 8320 in the washing chamber 8310 may accommodate different sizes of build platforms. The integration of these components, from the washing chamber and circulation system to the drying system and user interface, may work together to provide a comprehensive solution for post-processing 3D-printed objects, optimizing cleaning efficiency while offering flexibility for different types of objects and materials.

In some embodiments, the washing system 8200 may be provided as a stand-alone device or may be integrated with, docked to, or otherwise coupled with one or more other post-processing devices, such as a post-curing unit (e.g., a UV/light curing chamber) and/or the 3D printer, to form a combined or modular post-processing system, optionally sharing a housing, controller, user interface 8240, and/or build-platform handling among washing, drying, and curing operations.

### Technical Effects and Advantages

Detachable wash solvent storage: In some embodiments, the detachable wash solvent storage 8210 may achieve an unexpected technical effect of effectively preventing cross-contamination between different resins, which is particularly important for 3D-printed objects requiring strict biocompatibility, such as those used in oral or medical applications. Compared with traditional integrated solvent storage systems, the system 8200 allows users to replace an independent storage 8210 based on the material type, thereby realizing physical isolation and dedicated solvent management. This design may not only significantly improve washing quality but also help ensure the safety of printed objects in subsequent use—a result that may be difficult to achieve with conventional washing systems.

Toroidal propeller: In some embodiments, the toroidal propeller 8400 may achieve a dual effect of enhanced washing efficiency and significantly reduced operational noise. By optimizing fluid flow paths, the toroidal propeller 8400 may effectively mitigate vortices and turbulence caused by pressure differentials, maintaining a low noise level even at high rotational speeds. Meanwhile, the liquid flow generated may be more stable and uniform, improving the solvent's surface coverage and impact force on the 3D-printed object, thereby enhancing overall washing performance.

Two-phase washing process: In some embodiments, the two-phase washing process may achieve more thorough cleaning with reduced solvent usage, enhancing washing efficiency while reducing overall solvent consumption. Compared to traditional full-immersion or single-mode agitation methods, the two-phase process may demonstrate advantages in both washing quality and resource utilization.

A number of implementations have been described. Nevertheless, it will be understood that various modifications may be made without departing from the spirit and scope of the disclosure. Accordingly, other implementations are within the scope of the following claims.

It is understood that any aspect and/or element of any embodiment of the washing system 8200 described herein may be combined in any way with any other aspect and/or element of any other embodiment of the washing system 8200 to form additional embodiments of the washing system 8200 all of which are within the scope of the washing system 8200.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification, unless stated otherwise. Thus, unless stated otherwise, each feature disclosed represents one example of a generic series of equivalent or similar features.

The present invention also covers the exact terms, features, values, and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A washing system for cleaning a three-dimensional (3D) printed object, the washing system comprising:
a main body;
a washing chamber disposed within the main body and configured to receive the 3D-printed object;
a backplate of the main body;
a wash solvent storage configured to hold a wash solvent;
a connection interface detachably coupling the wash solvent storage to the backplate and establishing fluid communication therebetween;
a pump fluidly coupled between the wash solvent storage and the washing chamber and configured to deliver the wash solvent from the wash solvent storage into the washing chamber and to return used wash solvent from the washing chamber to the wash solvent storage; and
an agitator disposed in a lower portion of the washing chamber and configured to agitate the wash solvent within the washing chamber.

2. The washing system of claim 1, wherein the connection interface comprises mutually complementary mating features on the wash solvent storage and the backplate that cooperate to support, align, or retain the wash solvent storage relative to the backplate.

3. The washing system of claim 2, wherein the mating features comprise a protruding portion provided on one of the wash solvent storage and the backplate, and a receiving portion provided on the other of the wash solvent storage and the backplate and configured to receive the protruding portion.

4. The washing system of claim 3, wherein the backplate defines a recessed receiving portion and includes a protruding portion within the recessed receiving portion, and wherein the wash solvent storage has an outer contour shaped to be received by the recessed receiving portion and defines a storage cavity shaped to receive the protruding portion.

5. The washing system of claim 1, wherein the agitator comprises a toroidal propeller having a plurality of blade elements arranged in a closed-loop configuration.

6. The washing system of claim 5, wherein the plurality of blade elements comprises three blade elements, each blade element being oriented at an angle of between approximately 35 and 65 degrees relative to a horizontal plane.

7. The washing system of claim 1, wherein the wash solvent storage includes an identification element storing information about the wash solvent including at least one of a usage cycle and a solvent type, and wherein the backplate includes a reader configured to read the information from the identification element.

8. The washing system of claim 7, wherein the identification element comprises a radio-frequency identification (RFID) tag and the reader comprises an RFID reader, and wherein the washing system is configured to, based on the information, at least one of (i) prompt a user to replace the wash solvent and (ii) verify whether the wash solvent storage is properly seated on the backplate.

9. The washing system of claim 1, wherein the wash solvent storage includes an internal conduit and a filter element secured to an end of the internal conduit, the filter element comprising one of a sponge and a metal mesh and being configured to prevent debris from returning to the washing chamber when the wash solvent is pumped from the washing chamber.

10. The washing system of claim 1, further comprising an anti-leakage conduit connecting the backplate to the washing chamber and configured to direct wash solvent leaked at the backplate into the washing chamber.

11. A method of washing a three-dimensional (3D) printed object, the method comprising:
delivering, with a pump, a wash solvent from a wash solvent storage into a washing chamber to a first level above an agitator;
performing a splash-washing phase by activating the agitator to spray the wash solvent upward onto the 3D-printed object; and
returning the wash solvent from the washing chamber to the wash solvent storage with the pump.

12. The method of claim 11, further comprising, after the splash-washing phase and before returning the wash solvent, delivering additional wash solvent into the washing chamber to a second level at which the 3D-printed object is submerged, and performing an immersion-rinsing phase by operating the agitator to circulate the wash solvent around the submerged 3D-printed object.

13. The method of claim 11, wherein the agitator comprises a toroidal propeller having three blade elements arranged in a closed-loop configuration.

14. The method of claim 12, wherein during the splash-washing phase the agitator is rotated at about 1800 to 2400 rpm, and during the immersion-rinsing phase the agitator is rotated at a lower speed of about 600 to 1000 rpm.

15. The method of claim 12, wherein the first level is about 5 mm above a surface of the agitator and the second level is about 70 mm above the agitator.

16. The method of claim 11, wherein returning the wash solvent comprises reversing the pump to draw the used wash solvent from the washing chamber back to the wash solvent storage along a same conduit path used for the delivering.

17. The method of claim 11, further comprising, after returning the wash solvent, drying the 3D-printed object by operating a drying system to direct a drying gas flow through the washing chamber.

18. A washing apparatus for a three-dimensional (3D) printed object, the washing apparatus comprising:
a washing chamber configured to hold a wash solvent and to receive the 3D-printed object; and
a toroidal propeller disposed in a lower portion of the washing chamber and configured to agitate the wash solvent,
wherein the toroidal propeller comprises a plurality of blade elements arranged in a closed-loop configuration, each blade element being oriented at an angle of between approximately 35 and 65 degrees relative to a horizontal plane, the closed-loop configuration being configured to reduce formation of tip vortices during rotation so as to lower operational noise relative to a non-closed-loop propeller.

19. The washing apparatus of claim 18, wherein each blade element of the toroidal propeller is oriented at an angle of approximately 45 degrees relative to the horizontal plane.

20. The washing apparatus of claim 18, further comprising a flow-directing feature extending inwardly from interior walls of the washing chamber and configured to redirect splashed wash solvent toward a center of, and upward within, the washing chamber, the flow-directing feature comprising one or more of a rib, a vane, a baffle, and a channel.
